(19) United States
(12) Patent Application Publication
(10) Pub. No.: US 2015/0164293 A1
(43) Pub. Date: Jun. 18, 2015

(54) FOLDING FILM CASSETTE AND TOILET SYSTEM USING THE SAME

(71) Applicant: NIHON SAFETY CO., LTD., Tokyo (JP)

(72) Inventors: Akio Shimanuki, Tokyo (JP); Yoshikazu Onishi, Tokyo (JP)

(73) Assignee: NIHON SAFETY CO., LTD, Tokyo (JP)

(21) Appl. No.: 14/406,934

(22) PCT Filed: Jun. 25, 2013
(86) PCT No.: PCT/JP2013/003972

§ 371 Date: Dec. 10, 2014

(30) Foreign Application Priority Data
Aug. 29, 2012 (JP) 2012-188911

(51) Int. Cl. A47K 11/02; B65F 1/06

(52) U.S. Cl. CPC A47K 11/026; B65F 1/062

(57) ABSTRACT

A folding film cassette including: a cassette base consisting of a first annular body with a substantially L-shaped cross-section that has a hole corresponding to a hole of a toilet in a center thereof and includes a first annular vertical wall onto which a folding film is to be fitted over the outside thereof and a horizontal wall extending outwards from a bottom end of the first annular vertical wall; and a film guide consisting of a second annular body that is detachably mounted onto a top end of the first annular vertical wall onto which the film has been fitted and includes an outer flange, in which the folding film that is retained in the cassette base is expanded from an outer edge of the outer flange of the film guide and fed into the hole of the cassette base.

### TECHNICAL FIELD

The present invention relates to a folding film cassette suitable for use a package-type toilet apparatus in which a film (hereinafter referred to as a “folding film”) obtained by multiply folding a long tubular plastic film (hereinafter referred to simply as a “film”) regularly for each fixed stroke in the lengthwise direction is pulled out while expanding the folding film from a state in which it is set to configure the folding film in a usage state (a packageable state), and further relates to a toilet system using such a cassette.

### BACKGROUND ART

A folding film for accommodating and packaging (seal packaging) excrement, garbage, and the like, as well as a package-type garbage packaging apparatus or toilet apparatus in which such a folding film is set for use are conventionally known as disclosed in Patent Literatures 1 to 6. The folding direction of the film can be either a radial direction or a lengthwise direction of a long tubular film. The following explanation will focus on an example of a film that is folded annularly in the radial direction.

The folding film has a substantially annular shape when viewed in the folded state from a plan view. Thus, in order to set such a film under the seat of a toilet apparatus, the following cumbersome operation must be carried out. First, the film is set after removing a film guide mounted under the seat in a state in which the periphery of the folding film which presents an annular shape is bound with tape or the like at, for example, four places so that the annular folded state does not come undone. Subsequently, the film guide which was removed is mounted again. Finally, the tape binding is released and the folding film is retained by hand in feed rollers of a heat sealing mechanism for sealing the opening of the film.

Further, when setting the folding film under the seat of a toilet apparatus after setting the folding film and releasing the binding of the tape or the like, if the annular inside and outside of the film edge that is meant to be pulled out of the film which is folded to present an annular shape are mixed up (it is the annular outer surface side that should be pulled out first), the folded state of the folding film whose binding has been released may come undone, and this may lead to loss of control of the folding film.

### CITATION LIST

### Patent Literatures

Patent Literature 1: JP 2004-261530 A

Patent Literature 2: JP 07-223617 A

Patent Literature 3: JP 06-13686 A

Patent Literature 4: JP 4263497 B1

Patent Literature 5: JP 11-100014 A

Patent Literature 6: JP 60-3705 Y

### SUMMARY OF INVENTION

### Technical Problem

The present invention is directed to a problem of providing a folding film cassette in which a folded state of the folding film can be neatly retained without binding with tape or the like and the folding film can be set in a toilet apparatus in this neatly retained state, as well as providing a toilet system using such a cassette.

### Solution to Problem

A preferred constitution of the folding film cassette according to the present invention that was created for the purpose of solving the above-described problem is characterized as follows: the folding film cassette includes a cassette base consisting of a first annular body with a substantially L-shaped cross-section that has a hole corresponding to a hole of a toilet in a center thereof and includes a first annular vertical wall onto which the folding film is to be fitted over the outside thereof and a horizontal wall extending outwards from a bottom end of the first annular vertical wall, and a film guide consisting of a second annular body with a substantially inverse L-shaped cross-section that is detachably mounted onto a top end of the first annular vertical wall onto which the film has been fitted and includes a second annular vertical wall and an outer flange formed on a top end of the second annular vertical wall.

In the present invention, the film guide is not limited to an annular body with a substantially inverse L-shape as described above, and can be realized as, for example, a film guide that is detachably formed in the shape of an outer flange on the first annular vertical wall by a positioning pin or the like.

According to the above-described constitution, the folding film that is retained on the cassette base can be pulled out and expanded such that the film which has been pulled out can be fed into the hole of the cassette base via the film guide.

The cassette according to the present invention constituted as described above is preferably formed by plastic molding the cassette base consisting of the first annular body, the film guide consisting of the second annular body, and a lid. However, the cassette is not limited to such plastic molded articles, and can also be made of, for example, thick paper or cardboard.

The cassette according to the present invention is configured in a set state by fitting the folding film onto the outside of the first annular vertical wall along the hole in the center of the cassette base. If the second annular vertical wall of the film guide is mounted onto the first annular vertical wall of the cassette base and then a hat-shaped lid is placed thereon, the lid can be placed over the cassette base on which the folding film is set and the film guide in an integrated state. Thereby, the entire cassette takes on the form of a box-shaped packaging, and thus it can be distributed, stored, and used in this form as a folding film cassette.

### ADVANTAGEOUS EFFECTS OF INVENTION

The present invention includes a cassette base consisting of a first annular body with a substantially L-shaped cross-section that has a hole corresponding to a hole of a toilet in a center thereof and includes a first annular vertical wall onto which the folding film is to be fitted over the outside thereof and a horizontal wall extending outwards from a bottom end of the first annular vertical wall, and a film guide consisting of a second annular body with a substantially inverse L-shaped cross-section that is detachably mounted onto a top end of the first annular vertical wall onto which the film has been fitted and includes a second annular vertical wall and an outer flange formed on a top end of the second annular vertical wall. The folding film that is retained on the cassette base can be pulled out and expanded to feed it into the hole of the cassette base via the film guide. Therefore, the operation of loading and setting a packaging film into a package-type toilet apparatus or waste accommodating apparatus that uses a folding film can be performed simply and accurately.

Also, the cassette according to the present invention can take on a packaged form in which the cassette base on which the film is set and the film guide are covered in an integrated state by a substantially hat-shaped or substantially box-shaped lid. Therefore, the cassette can be distributed, stored, and used in this form, and this is advantageous with respect to both the distribution and user stages.

Furthermore, in a toilet system utilizing the cassette according to the present invention, it is not necessary to attach a unique film guide on the toilet apparatus side, and thus the toilet apparatus can be provided inexpensively and with a simpler structure.

### BRIEF DESCRIPTION OF DRAWINGS

FIG. 1 is a perspective view of a folding film cassette according to the present invention in a disassembled state.

FIG. 2 is a plan view of a cassette base of the cassette according to the present invention.

FIG. 3 is a center transverse plan view of FIG. 2.

FIG. 4 is a plan view of a film guide of the cassette according to the present invention.

FIG. 5 is a center transverse plan view of FIG. 4.

FIG. 6 is a perspective view illustrating an unused state in which a lid is placed on the cassette according to the present invention.

FIG. 7 is a perspective view illustrating a state in which the lid of FIG. 6 is removed, in which a pulled out film portion is omitted from the drawing.

FIG. 8 is a perspective view illustrating an actual unused state in which the lid of FIG. 6 is removed.

FIG. 9 is a perspective view illustrating a stage in which the film is sandwiched by feed rollers, in which the lid is omitted from the drawing.

FIG. 10 is a schematic cross-section view of an example of a toilet apparatus in which the cassette according to the present invention has been set.

### DESCRIPTION OF EMBODIMENTS

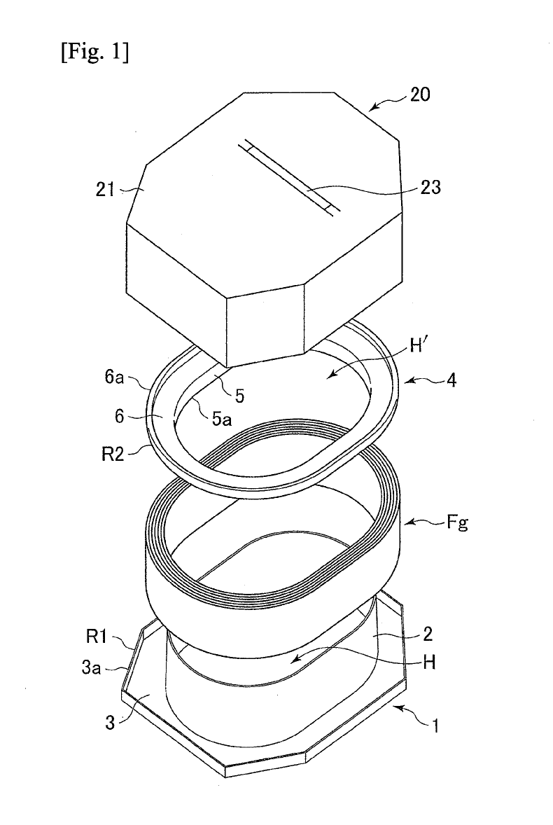

Next, an embodiment of the cassette according to the present invention and the toilet system according to the present invention using the cassette will be explained with reference to the drawings. In FIG. 1 which illustrates the cassette according to the present invention in a disassembled state, Fg indicates a folding film formed by folding a long tubular film in a zigzag pattern in the radial direction so that it presents a bundled annular shape.

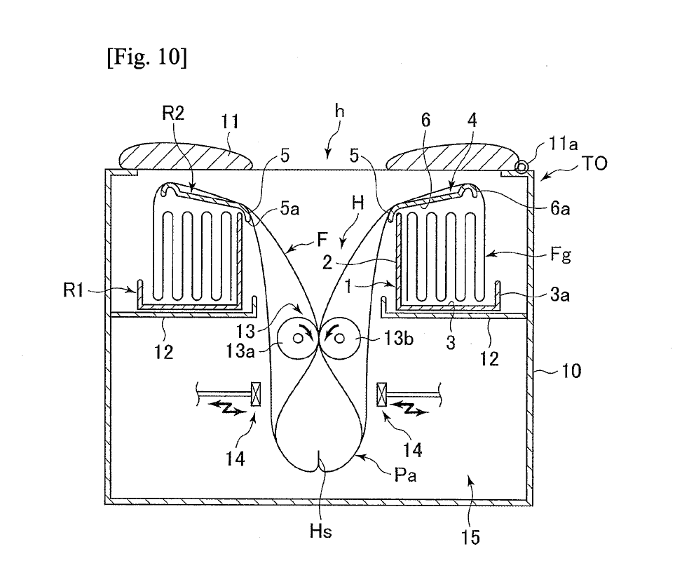

In FIGS. 1, 2, and 3, 1 indicates a cassette base formed such that the annular folding film Fg can be set thereon while retaining its annular shape. Herein, the cassette base 1 is formed by a first annular body R1 with a substantially L-shaped cross-section, which is formed by a first annular vertical wall 2 that stands along an inner peripheral edge of a hole H and a horizontal wall 3 that extends outwards horizontally from a bottom end of the vertical wall 2. The hole H is formed in the cassette base 1 so as to match the planar shape of a hole h of a seat 11 of a toilet apparatus to which the toilet system according to the present invention is applied as shown in the side cross-section view in FIG. 10.

Herein, the cassette base 1 formed by the first annular body R1 is a molded body made of a plastic material. The annular vertical wall 2 is formed with a shallow inverse tapered angle due to the specifications of the mold, but the vicinity of the top end of the wall is substantially vertical. Also, the outer peripheral edge of the horizontal wall 3 is substantially entirely formed into an erect edge 3a that stands up vertically. The erect edge 3a serves as an area for ensuring the deformation strength of the cassette base 1 and receiving a lid 20 which becomes a packaging to be explained later.

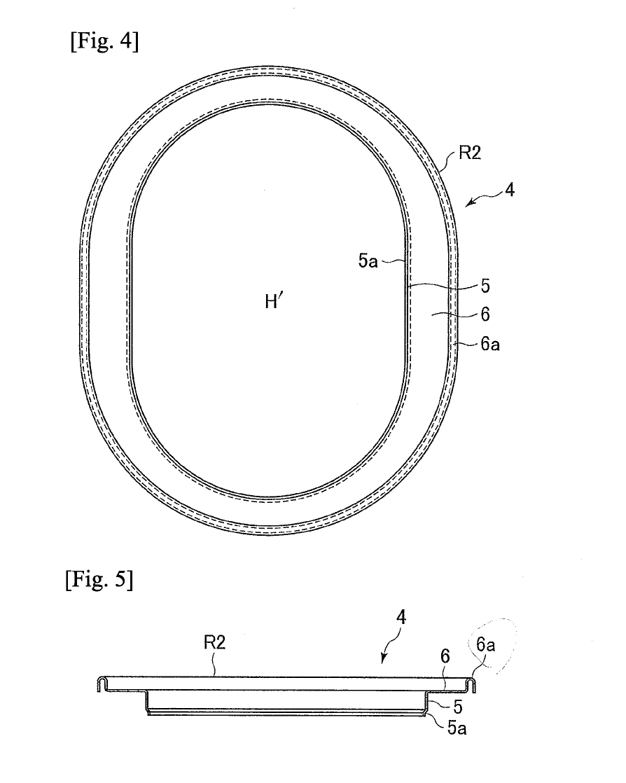

In FIGS. 1, 4, and 5, 4 indicates a film guide formed by a second annular body R2 with a substantially inverse L-shaped cross-section that includes the following: a second annular vertical wall 5 which has a height that is shorter than that of the first vertical wall 2, is the same shape as the first annular vertical wall 2 of the cassette base 1, and has an engaging part 5a that fits into the top end of the vertical wall 2 formed on its bottom end; and an outer flange 6 that is formed to extend outward from the top end of the second vertical wall 5 and has an edge 6a that rises up with a substantially inverse U-shaped cross-section on the outer periphery of the extending portion thereof . In the center of the film guide 4, a hole H′ that is substantially the same shape as the hole H in the center of the cassette base 1 is formed.

The film guide 4 of the present invention is not limited to the example explained above. For example, although not illustrated, the film guide can be configured by detachably mounting a second annular body R2, which is formed by an outer flange 6 having an edge 6a similar to the above-described example except without the second annular vertical wall 5, onto the top end of the vertical wall 2 of the first annular body R1 with a positioning pin or some other fastening member.

The cassette base 1 and the film guide 4 formed by the two annular bodies R1 and R2 are used to complete the folding film cassette according to the present invention in which the folding film Fg is set as in the embodiment illustrated in FIG. 7 as follows: first, the folding film Fg obtained by folding a long tubular film in an annular direction to present an annular shape is fitted over the outside of the annular vertical wall 2 of the cassette base 1 in a horizontal posture; and then in this state, the film guide 4 is fitted at the engaging part 5a formed on the bottom end of the annular vertical wall 5 onto the top end of the annular vertical wall 2 of the cassette base 1. Herein, the cassette base 1 and the film guide 4 formed by the two annular bodies R1 and R2 which have been joined as described above form a film holder of the cassette according to the present invention. Therefore, the cassette base 1 and the film guide 4 which have been joined together may be referred to collectively as a “film holder” hereinafter.

FIG. 7 is a perspective view illustrating the film holder in a state in which a portion where the folding film Fg which has been set is pulled out is omitted from the drawing. However, as exemplified in FIG. 8, a folding terminal end portion of the folding film Fg (a leading end portion when the folding film Fg is pulled out and expanded) is actually in a state in which the end of a tubular film F that is pulled out is converged by a method such as heat sealing. Therefore, the pulled out portion of the film F and a heat sealed part Hs are in a shape that blocks the hole H (H′) of the two vertical walls 2 and 5 formed by the first and second annular bodies R1 and R2 (refer to FIG. 8).

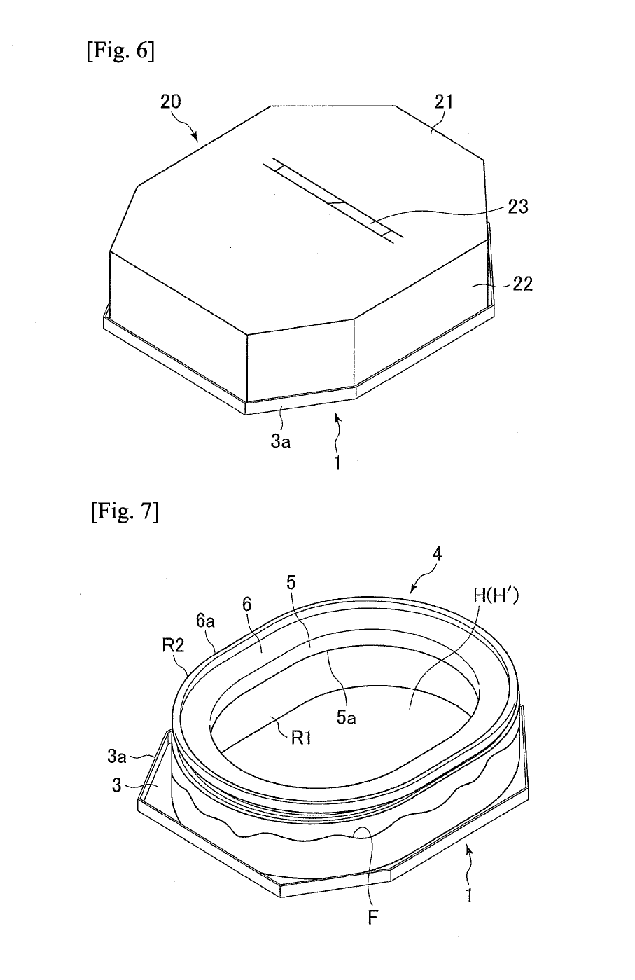

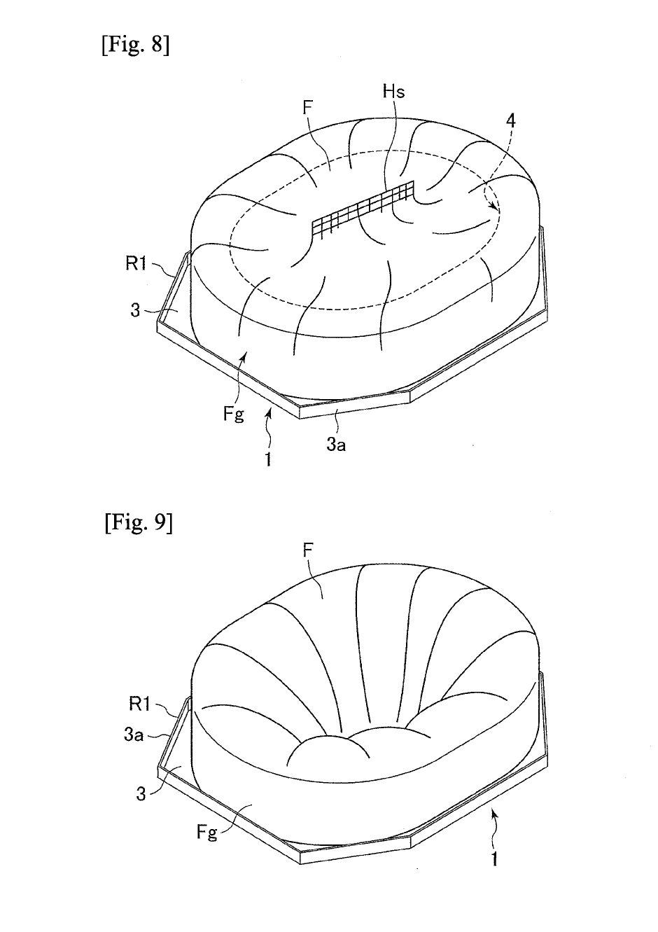

Given the above, the cassette according to the present invention is put into a distribution, storage, and usage stage by configuring it into the form shown in FIG. 6 by placing the lid 20 of FIG. 1 thereon in the state shown in FIG. 8.

The cassette according to the present invention in which the lid 20 has been placed thereon in the state shown in FIG. 8 is set in the form in which the lid 20 is placed thereon shown in FIG. 6 under the seat 11 of a toilet apparatus TO which constitutes the toilet system according to the present invention illustrated in FIG. 10. In other words, in the cassette according to the present invention onto which the lid 20 has been placed, a tongue-shaped flat tool (not illustrated) is inserted from a slit hole 23 provided on the lid 20, and then the film F including the heat sealed part Hs shown in FIG. 8 which exists within the lid 20 is pushed down by the inserted tool and sandwiched between feed rollers 13a and 13b of the toilet apparatus TO. Once sandwiched therebetween, the lid 20 is removed and the cassette according to the present invention is in the state shown in FIG. 10.

The toilet apparatus TO of FIG. 10 has the following constitution as one example. In FIG. 10, the toilet apparatus TO is formed by the following: a seat 11 that is substantially 0-shaped or U-shaped in a plan view and is provided such that it can be raised and lowered on an opening of a casing 10 whose top part is largely opened by a hinge 11a at the top end opening of the casing 10; a partitioning panel 12 that partitions the inside of the casing 10 at a middle part in the up-down direction; a feed roller mechanism 13 for the film F that is pulled out and expanded and a heat sealing mechanism 14 for heat sealing and cutting the film F that are arranged below the partitioning panel 12 ; and an accommodating part 15 that is below the mechanisms 13 and 14 for accommodating a packaging Pa formed by the heat sealed film F. The above-described constitution of the toilet apparatus TO is a general constitution, and the structure of the actual toilet apparatus to which the cassette according to the present invention is applied is not limited to the above-described constitution.

When viewing the toilet apparatus TO of FIG. 10 in a plan view, the rollers 13a and 13b of the film feed mechanism 13 exist at the front side and the back side of the paper surface in FIG. 10 (the rollers 13a and 13b in FIG. 10 are at the back side). The rollers 13a and 13b function to sandwich and retain both ends of the tubular film F that has been pulled out through the film guide 4, and then the rollers 13a and 13b pull out the film F that has been sandwiched from the film holder in which the folding film Fg has been set by rotating in the directions indicated by the arrows to feed the film F toward the underside of the roller mechanism 13.

The cassette according to the present invention, which is configured such that the folding film Fg for packaging can be set in a cassette style in the package-type toilet apparatus TO as explained above, can be set in the toilet apparatus TO in a state in which the folding film Fg is set in the film holder formed by joining the cassette base 1 and the film guide 4 and the lid 20 is placed onto the film holder. Therefore, the cassette according to the present invention can be distributed and stored in a home or the like in the form in which it is covered with a packaging consisting of the substantially box-shaped lid 20.

Next, the packaged form of the cassette according to the present invention will be explained.

FIG. 6 is a perspective view of a packaged state in which the box-shaped lid 20, which can package the cassette by being placed from above over the cassette according to the present invention in its assembled state, is placed onto the film holder in which the folding film Fg has been set. FIG. 7 is a perspective view illustrating the cassette in a usage state in which the lid 20 of FIG. 6 has been removed, in which the terminal end of the folding film Fg is omitted from the drawing.

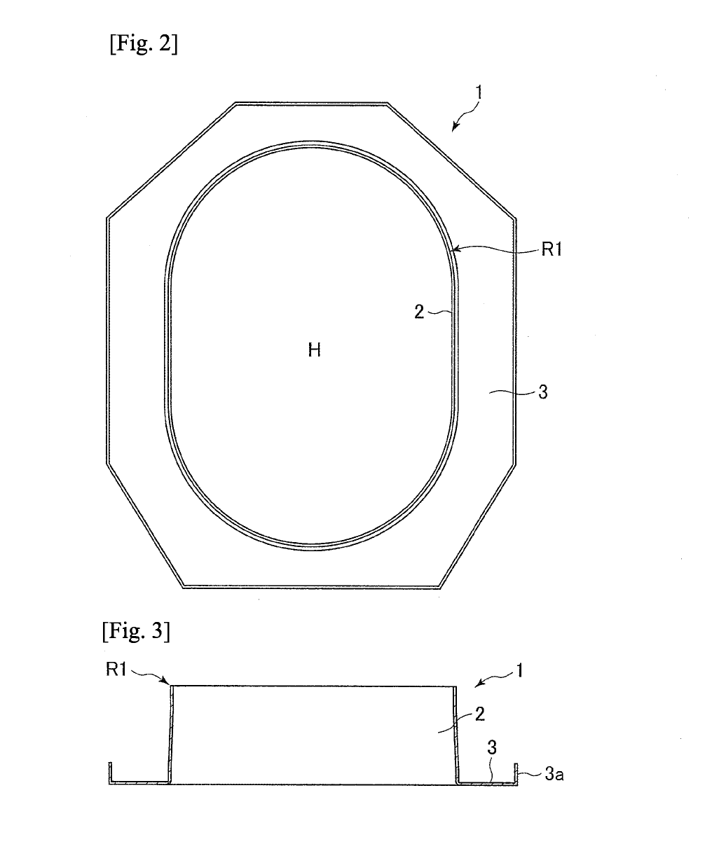

In the present invention, the cassette base 1 formed by the first annular body R1 has a substantially octagonal planar shape obtained by cutting off the four corners of a basic rectangle shape as shown in FIGS. 1 and 2. Therefore, when the lid 20 is placed onto the film holder formed by joining the cassette base 1 and the film guide 4, a bottom edge of the peripheral wall of the lid 20 engages with the erect edge 3a of the cassette base 1. Thus, the lid 20 which becomes the packaging as shown in FIG. 6 is formed in substantially the same shape as the planar shape of the cassette base 1 in a plan view.

In other words, the lid 20 that is placed onto the cassette holder shown in FIG. 6 is formed from a lid part 21 having a shape that is the same as the planar shape of the erect edge 3a of the cassette base 1 and a vertical wall 22 that has a shape that is the same as the planar shape of the cassette base 1 and is formed to hang down from the periphery of the canopy part 21. The lid 20 is also provided with a slit-shaped through hole 23 on the canopy part 21. The rectangular slit-shaped through hole 23 provided at a center area of the canopy part 21 is provided at a position at which the contact areas of the rollers 13a and 13b of the roller mechanism 13 which feeds the film F downwards abut substantially directly under both ends of the hole 23. In the present invention, although not illustrated, a lid 20 which does not include the slit-shaped through hole 23 can also be used.

When the lid 20 constituted as described above is placed from above onto the film holder in which the folding film Fg has been set, the lid 20 almost completely covers the film holder (the cassette base 1 and the film guide 4 which have been joined together) in which the folding film Fg has been set in a state in which the bottom end over the entire periphery of the vertical wall 22 which is formed to hang down from the periphery of the canopy part 21 of the lid 20 is engaged with the erect edge 3a on the periphery of the cassette base 1. Therefore, the cassette according to the present invention can be distributed and stored in the market in this state as a packaged state, and then stored and used as is in this state by a user.

Accordingly, the cassette according to the present invention in the packaged state shown in FIG. 6 can be set into the toilet apparatus TO without removing the lid 20 by raising the seat 11 of the toilet apparatus TO and installing the cassette base 1 onto the partitioning panel 12 in the state in which the folding film Fg has been set in the film holder.

In other words, with regard to the folding film Fg that is set in the film holder, the film F is pulled out from its outer peripheral surface side and the distal end thereof is formed by the heat sealed part Hs so as to be closed. Therefore, if the lid 20 includes the through hole 23, when the tongue-shaped flat tool is inserted from the slit-shaped through hole 23 to push down the distal end of the film F, the distal end of the film F including the heat sealed part Hs is sandwiched between the rollers 13a and 13b of the roller mechanism 13. Thereby, the operation for setting the cassette according to the present invention in the toilet apparatus TO is complete. If the lid 20 does not include the through hole 23, the lid 20 should be removed before sandwiching the film F between the rollers 13a and 13b of the roller mechanism 13 with the flat tool. The film F can also be sandwiched between the rollers 13a and 13b without using the flat tool by using another tool or by hand.

Also, in the present invention, a folding film Fg in which the distal end of the film F is not formed by the heat sealed part Hs in advance can be used.

As explained above, in order to configure a film used in a package-type toilet apparatus, in which a folding film is used to seal and package excrement every time it is excreted, such that it can be set in a toilet in a cassette style, the present invention configures the folding film cassette so as to include a cassette base consisting of a first annular body with a substantially L-shaped cross-section that has a hole corresponding to a hole of a toilet in a center thereof and includes a first annular vertical wall onto which the folding film is to be fitted over the outside thereof and a horizontal wall extending outwards from a bottom end of the first annular vertical wall, and a film guide consisting of a second annular body with a substantially inverse L-shaped cross-section that is detachably mounted onto a top end of the first annular vertical wall onto which the film has been fitted and includes a second annular vertical wall and an outer flange formed on a top end of the second annular vertical wall. Therein, the folding film which is fitted and retained over the outside of the vertical wall of the cassette base is pulled out and expanded and then fed into the hole of the cassette base via the film guide. Therefore, the folding film can be completely prevented from coming undone as occurred when setting in a conventional manner.

Further, the cassette according to the present invention can be formed into a packaged state in which it is nearly completely packaged by merely placing a box-shaped lid thereon from above in a form in which the folding film has been set in a film holder of a shape obtained by joining the two annular bodies. Therefore, the folding film for a package-type toilet apparatus can be handled in a neat form during both distribution and storage, and the folding film can be set with the lid attached to sandwich the film between feed rollers during use. Therefore, the operation of setting the film in the toilet apparatus can be greatly simplified.

In addition, in a toilet system utilizing the cassette according to the present invention, it is not necessary to attach a unique film guide on the toilet apparatus side, and thus the toilet apparatus can be provided inexpensively and with a simple structure.

### REFERENCE SIGNS LIST

Fg: folding film
Pa: packaging formed by the folding film
Hs: heat sealed part
H, H′: hole
R1: first annular body
1: cassette base
2: first annular vertical wall
3: horizontal wall
3a: erect edge
R2: second annular body
4: film guide
5: second annular vertical wall
5a: engaging part
6 outer flange
6a: edge
TO: toilet apparatus
10: casing
11: seat
12: partitioning panel
13: roller mechanism
14: heat sealing mechanism
15: accommodating part of packaging Pa
20: lid which becomes a packaging
21: canopy part
22: vertical wall
23: slit-shaped hole

1. A folding film cassette comprising:
a cassette base consisting of a first annular body with a substantially L-shaped cross-section that has a hole corresponding to a hole of a toilet in a center thereof and includes a first annular vertical wall onto which a folding film is to be fitted over the outside thereof and a horizontal wall extending outwards from a bottom end of the first annular vertical wall; and
a film guide consisting of a second annular body that is detachably mounted onto a top end of the first annular vertical wall onto which the film has been fitted and includes an outer flange,
wherein the folding film that is retained in the cassette base is expanded from an outer edge of the outer flange of the film guide and fed into the hole of the cassette base.

2. The cassette according to claim 1, wherein the outer flange comprises a second annular vertical wall that is mounted onto a top end of the first annular vertical wall.

3. The cassette according to claim 1, further comprising a substantially box-shaped lid that is placed on the first annular body and the second annular body in a state in which they are joined together and the folding film is set therein, wherein a slit-shaped through hole is provided on a top surface of the lid at a position corresponding to feed rollers of the film, or alternatively the through-hole is not provided.

4. The cassette according to claim 1, wherein a distal end of a tubular film that is expanded from an outer edge of the outer flange of the film guide and fed into the hole of the cassette base is closed.

5. A toilet system using a folding film cassette, wherein a folding film cassette is obtained by placing either a substantially box-shaped lid provided with a hole for inserting a flat tool for pushing down a long tubular film or a substantially box-shaped lid that is not provided with the hole for inserting onto a film holder formed by a first annular body with a substantially L-shaped cross-section onto which a folding film obtained by annularly folding the long tubular film is set and a second annular body that is joined to the first annular body,
the folding film cassette is set under a seat of a toilet apparatus in which the film can be sandwiched by a feed roller mechanism and fed downwards and an opening of the film which has been sent can be heat sealed and cut by a heat sealing mechanism,
therein, if the lid that has the hole for inserting is used, the flat tool is inserted from the hole for inserting to sandwich the film in the feed roller mechanism and then the lid is removed, and if the lid that does not have the hole for inserting is used, the lid is removed from the film holder onto which it is placed and then the film is sandwiched in the feed roller mechanism using the flat tool or without the flat tool, and
thereby, the film is configured in a usage state.

6. The cassette according to claim 2, further comprising a substantially box-shaped lid that is placed on the first annular body and the second annular body in a state in which they are joined together and the folding film is set therein, wherein a slit-shaped through hole is provided on a top surface of the lid at a position corresponding to feed rollers of the film, or alternatively the through-hole is not provided.

7. The cassette according to claim 2, wherein a distal end of a tubular film that is expanded from an outer edge of the outer flange of the film guide and fed into the hole of the cassette base is closed.

8. The cassette according to claim 3, wherein a distal end of a tubular film that is expanded from an outer edge of the outer flange of the film guide and fed into the hole of the cassette base is closed.
